(19) United States
(12) Patent Application Publication
(10) Pub. No.: US 2014/0353927 A1
(43) Pub. Date: Dec. 4, 2014

(54) FIRE AND CHEMICAL RESISTANT GASKET

(71) Applicant: Richard Schroder, Lebanon, OH (US)

(72) Inventor: Richard Schroder, Lebanon, OH (US)

(21) Appl. No.: 13/909,508

(22) Filed: Jun. 4, 2013

(51) Int. Cl. F16L 23/18

(52) U.S. Cl. CPC F16L 23/18
USPC 277/626; 277/602; 277/627

(57) ABSTRACT

The gasket 10 provides a fluid-tight seal between adjacent process pipes 12,14 or other conduits having external 16 and internal 18 surfaces. The gasket comprises a chemically inert, fire-suppressing shell 20 and a fire-resistant insert 22 mounted in the shell. The shell 20 is formed or molded with a base 24 having an inner surface 26 corresponding to the internal surfaces 18 of the pipes and with a pair of spaced-apart side walls 28, 30 extending from the base 24 and defining an outwardly opening, insert-receiving channel 32. Upon mounting the insert 22 in the channel 32, an exposed perimeter portion 34 of the insert provides a fire-resistant outer barrier between the external surfaces 16 of the process pipes.

### CROSS REFERENCE TO RELATED APPLICATION

This application is a Continuation-in-Part of U.S. patent application Ser. No. 12/853,716 filed Aug. 10, 2010.

### BACKGROUND OF THE INVENTION

1. Field of the Invention

The present invention relates to the design and fabrication of gaskets, o-rings and seals adapted to provide a fluid tight seal between industrial process pipes and more particularly to those suitable for use where flammable substances may be included in the process stream.

2. Related Art

Fire safety has always been a concern for industrial plant workers and the communities that surround them. Fires can be costly in terms of lives and property if they occur in industries that contain few if any combustible chemicals. Where the process piping carries flammable materials, fire prevention is an even greater concern. Leaks or ruptures in these systems can compound the problem of fire containment, cause explosions, pollute the environment, and further endanger life and property.

The process piping used in paint lines and chemical industries is often fabricated from stainless steel and provides adequate protection in a fire for a reasonable amount of time. However, where the stainless pipe sections are joined, a gasket is normally used. These gaskets can be the “weak link” in a fire, as they are likely to burn through first. They need to be sufficiently compressible to form a seal between the pipes, chemically resistant to corrosive or highly reactive chemicals and fire resistant. In the past, it has been difficult to satisfy all these requirements in the same gasket.

Some prior art piping gaskets with fire resistant properties are annular rings that contain composite/laminate structures or cores. U.S. Pat. No. 5,407,214, to Lew et. al. teaches chemical expansion of an inner steel capsule within gasket material. The capsule contains material that expands in the event of a fire to maintain the seal between process pipes.

In the present inventor's view, these earlier fire-resistant gaskets were too complex. There was a need for a more simply constructed gasket that was resistant to both chemicals and fire and that was sufficiently compressible to form a leak-proof seal during normal use and for a reasonable amount of time when exposed directly to flame or to the intense heat generated by a fire.

### SUMMARY OF THE INVENTION

The present gasket is adapted to provide a fluid-tight seal between adjacent process pipes or other conduits having external and internal surfaces. The gasket comprises a chemically inert, fire-suppressing shell and a fire-resistant insert mountable in the shell. The shell may be formed or molded with a base having an inner surface corresponding to the internal surfaces of the pipes and with a pair of spaced-apart side walls extending from the base and defining an outwardly opening, insert-receiving channel. Upon mounting the insert 2 in the channel an exposed perimeter edge or wall of the insert is disposed to provide a fire-resistant external barrier between the external surfaces of the process pipes.

### BRIEF DESCRIPTION OF THE DRAWINGS

FIG. 1 is an exploded sectional view of an exemplary form of the gasket disposed between process pipe flanges;

FIG. 2 is a front view of a fire-resistant insert for the gasket;

FIG. 3 is a front view of a fire-suppressing shell for the gasket;

FIG. 4 is a fragmentary side view of an alternative form of the gasket mounted between adjoining process pipes through which a process stream flows;

FIG. 5 is a front view of the alternative form of the gasket;

FIG. 6 is a side view thereof;

FIG. 7 is an enlarged sectional view of the gasket taken along line 7-7 of FIG. 6;

FIG. 8 is an enlarged sectional view taken along line 8-8 of FIG. 4; and

FIG. 9 is a front view of the alternative insert for the subject gasket.

### DETAILED DESCRIPTION OF EXEMPLARY AND ALTERNATIVE EMBODIMENTS

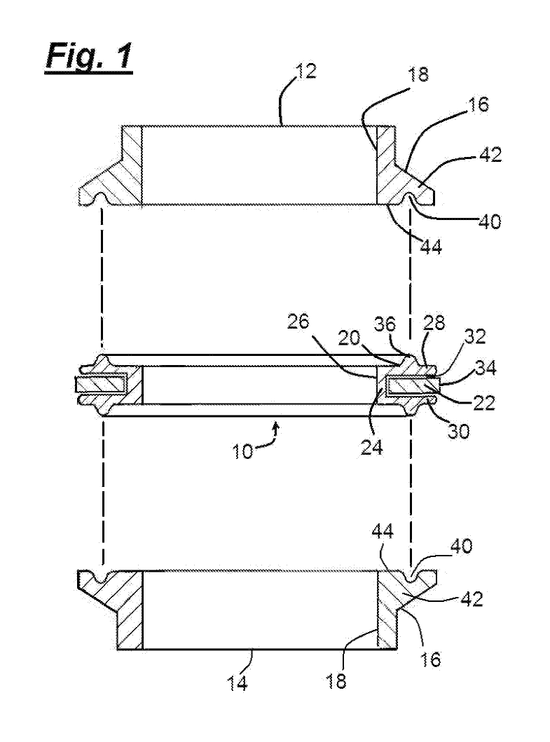

As illustrated in FIGS. 1-3, the present gasket, generally designated 10, is adapted to provide a fluid-tight seal between adjacent process pipes 12,14 or other conduits having external 16 and internal 18 surfaces. The gasket comprises a chemically inert, fire-suppressing shell 20 and a fire-resistant insert 22 mountable in the shell. The shell 20 may be formed or molded with a base 24 having an inner surface 26 corresponding to the internal surfaces 18 of the pipes and with a pair of spaced-apart side walls 28, 30 extending from the base 24 and defining an outwardly opening, insert-receiving channel 32. Upon mounting the insert 22 in the channel 32, an exposed perimeter edge or wall 34 of the insert is disposed to provide a fire-resistant outer barrier between the external surfaces 16 of the process pipes.

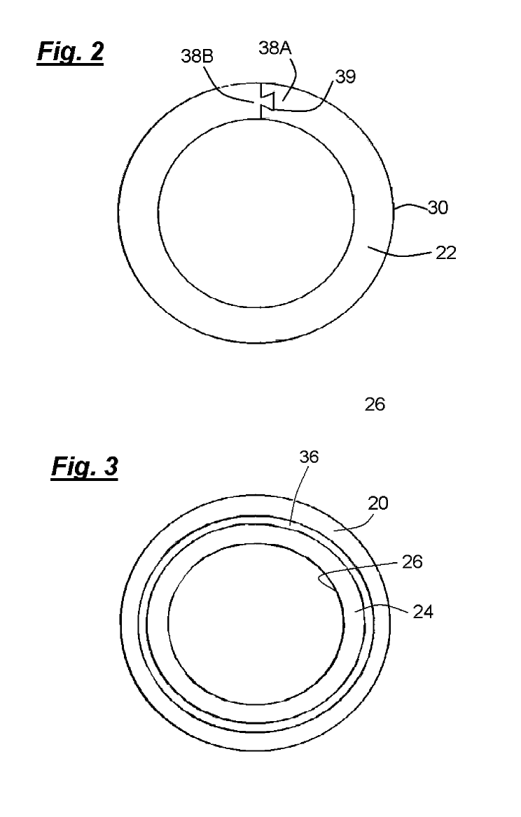

As further illustrated in FIGS. 1-3, the gasket 10 preferably includes the following features, The fire-resistant characteristic of the insert 22 may be provided, at least in part, by forming the insert from carbon fiber, and the fire suppressing characteristic of the shell 20 may be provided, a least in part, by incorporating one or more halogen compounds therein. The side walls 28,30 of the shell may be formed with flange-engaging ridges 36, 38, respectively. The ridges 36, 38 may correspond to and be mountable in grooves 40 formed in mating surfaces 44 of radially outwardly projecting flanges 42. In this manner, the present gasket is more likely to remain properly positioned when the flanges and gasket are operatively connected. As illustrated in FIG. 2, the, fire-resistant insert 22 may be formed with adjoining segments 38A,38B having a dovetail-shaped fissure 39 extending radially there through. The dovetail fissure 39, or other configuration, permits the adjoining segments of the insert to be separated and reconnected. In this manner, the fire resistant insert 22 may be mounted in or removed from the channel 32 between the side walls 28, 30 of the shell without being deformed.

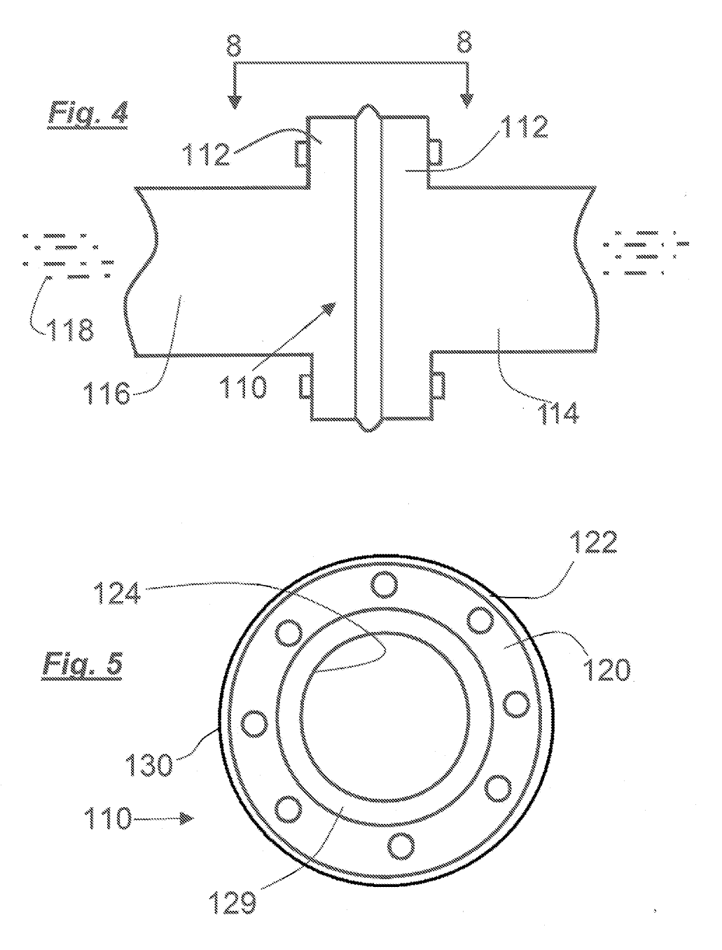

As illustrated in FIGS. 4-9, an alternative form of the present gasket, generally designated 110, is adapted to be mounted between opposing flanges 112 on a pair of process pipes or conduits 114, 116 through which a process stream 118 flows. i The gasket 110 comprises a shell 120 formed from chemically inert, fire-suppressing material and an annular core or insert 122 formed from fire resistant and compressible material. For example, the shell 120 may be formed from partially or fully halogenated polymers or co-polymers that, upon reaching its boiling point, emit fire suppressing fumes. The core 122 may be formed from an elastomeric matrix 122A and a non-combustible filler 1228 (FIG. 7) such as glass beads or carbon fiber.

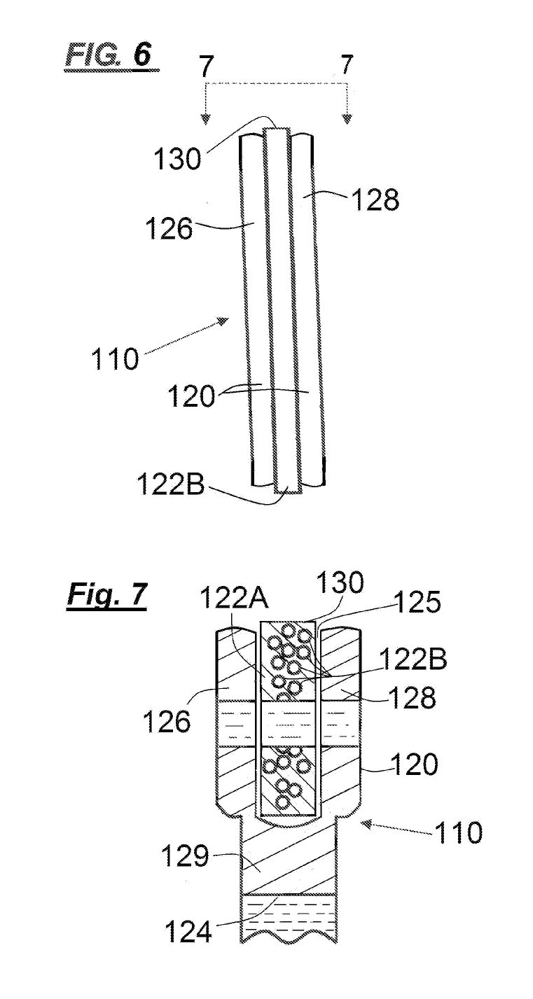

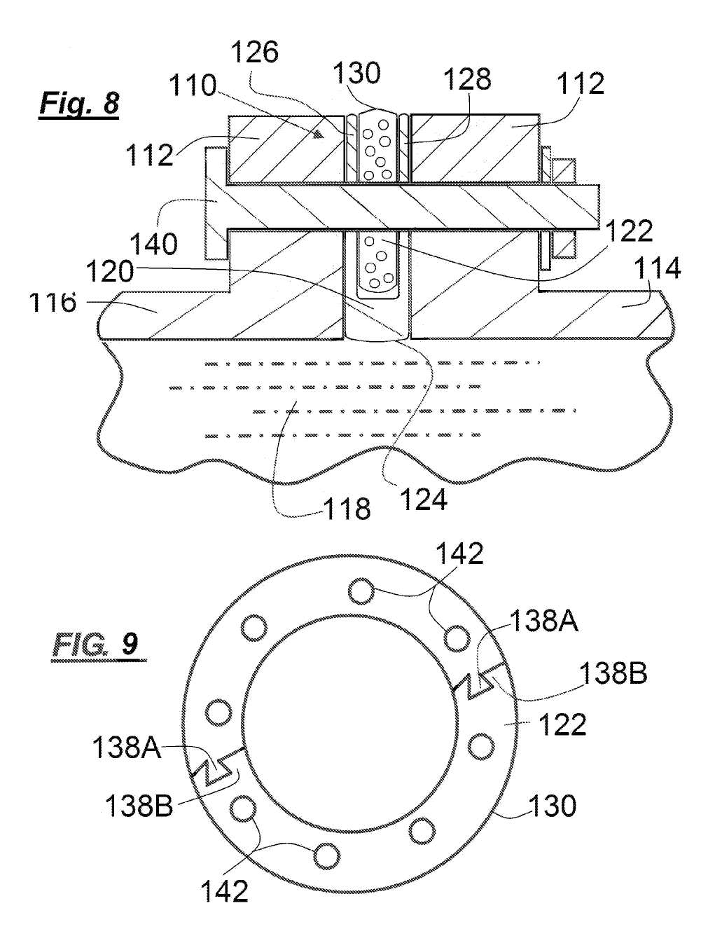

The shell 120 may be formed with a radially inwardly disposed, generally cylindrical surface 124 (FIG. 5) and with a pair of flange-engaging sidewalls 126, 128 (FIGS. 6,7) The shell and its inwardly disposed, chemically inert surface 124 I may be compressed between the conduit flanges 112 (FIG. 8) to form a fluid tight seal adjacent to the process stream 118 upon tightening the gasket 10 between the flanges 112,114, thereby preventing the process stream 118 from reaching the relatively more chemically reactive insert 122. An outwardly opening, annular slot or channel 125 (FIG. 7) may be formed between the sidewalls 126, 128 of the shell 120 and may be disposed to receive a substantial portion ,such as 75-95%, of the insert 122. Alternatively, the shell 120 may be over-molded around at least the portion of the insert 122. The sidewalls 126, 128 may be raised relative to a base portion 129 (FIG. 7) of the shell 120. In this manner, additional compressive force may be applied to the insert 122 upon tightening the bolts 140 or other fasteners (FIG. 8) extending through the flanges 112 and gasket 110. In addition, the side-walls 126, 128, once compressed between the conduit flanges 112, may serve as a backup fluid-tight seal to prevent the potentially corrosive or oxidative process stream118 from reaching the insert 122.

The insert 122 may have a received portion 123 disposed between the shell sidewalls 126, 128, and an exposed portion 130 projecting radially outwardly from the shell 120 (FIG. 7). As illustrated in FIG. 9, the insert may be formed with one or two pairs of interlockable sections 138A, 138B extending generally diametrically therethrough. The sections 138A,B may have a dovetail configuration. In this manner, the fire resistant insert 122 may be mounted in or removed from the slot or channel 125 in the shell 120 without breaking, and the adjoining sections may substantially maintain the fire-resistant properties of the insert 122.

As illustrated in FIG. 8, t the shell 120 and the insert 122 may be compressed and slightly deformed when the gasket 110 is installed and compressed between the process pipe flanges112 by means of conventional fasteners 140 extending through the flanges 112 and the gasket 110. Upon assembly, the inwardly disposed surface 124 of the shell may bulge slightly into the process stream 118 and the outer end 130 of the insert may bulge slightly beyond the conduit flanges 112. In this manner, the outer end 130 may protect the relatively less fire resistant shell from heat and flames. As indicated in FIGS. 5 and 9, the insert 122 and the shell 120 may be formed with a plurality of spaced apart, relatively alignable, fastener-receiving bores 142.

The foregoing description of exemplary and alternative forms of the present gasket is not intended to unduly limit or restrict the scope or construction of the following claims.

1. A gasket adapted to provide a fluid-tight seal between adjacent process conduits, each of said conduits having an internal bore-defining surface and an external surface, said gasket comprising:
a chemically inert, fire-suppressing shell formed with a base, said base having an inner surface corresponding to the internal surfaces of the conduits and with a pair of spaced-apart side walls extending from the base and defining an outwardly opening, insert-receiving channel.; and
a fire-resistant insert mountable in the shell channel, said insert having an exposed perimeter portion projecting outwardly from said shell channel and extending between the external surfaces of the process conduits, said exposed perimeter portion being disposed to provide a fire resistant outer barrier on said gasket.

2. The gasket according to claim 1, wherein the insert is composed at least in part of carbon fibers.

3. The gasket according to claim 1, wherein the the shell is composed a least in part of a halogen compound.

4. The gasket according to claim 1, wherein each of the sidewalls of the shell is formed with a circular ridge.

5. The gasket according to claim 4, wherein the circular ridge is sized and positioned to be seated in a circular groove in a flange formed on an adjacent process conduit.

6. The gasket according to claim 1, wherein the fire-resistant insert is formed with at least one pair of adjoining portions.

7. The gasket according to claim 6, wherein the adjoining portions are separable and reconnectable.

8. A gasket mountable between the opposing flanges of two process conduits disposed to conduct a process stream, said gasket comprising:
a. an annular chemically inert and fire-retardant shell formed with base portion having a radially inwardly disposed,process stream-engaging surface and with a pair of spaced apart, flange-engaging sidewalls,
b. an annular fire-resistant insert removably receivable between the sidewalls the shell and said insert having a radially outwardly disposed end; and
c. said shell providing a fluid-tight barrier between the opposing flanges of the process conduits and the outwardly disposed end of said insert providing a fire-resistant barrier between said opposing flanges.

9. The gasket according to claim 8, wherein the shell is formed from halogenated polymers, and the insert is formed from an elastomeric matrix and a non-combustible filler.

10. The gasket according to claim 8, wherein the sidewalls are raised relative to the base portion of the shell.

11. The gasket according to claim 8, wherein the shell is formed with at least one substance that emits fire suppressing fumes upon reaching its boiling point.
